(19) United States
(12) Patent Application Publication
(10) Pub. No.: US 2016/0047924 A1
(43) Pub. Date: Feb. 18, 2016

(54) Determination of Subsurface Properties in the Vicinity of a Well by Full Wavefield Inversion

(71) Applicants: Christine Krohn, Houston, TX (US); Partha S. Routh, Katy, TX (US); John E. Anderson, Spring, TX (US); Gboyega Ayeni, Humble, TX (US); Kenneth E. Green, Houston, TX (US)

(72) Inventors: Christine Krohn, Houston, TX (US); Partha S. Routh, Katy, TX (US); John E. Anderson, Spring, TX (US); Gboyega Ayeni, Humble, TX (US); Kenneth E. Green, Houston, TX (US)

(21) Appl. No.: 14/800,147

(22) Filed: Jul. 15, 2015

Related U.S. Application Data
(60) Provisional application No. 62/037,464, filed on Aug. 14, 2014.

(51) Int. Cl. G01V 1/28; G06F 17/10

(52) U.S. Cl. CPC G01V 1/282; G06F 17/10; G01V 2210/66

(57) ABSTRACT

A method, including: obtaining an initial model of a subsurface property; simulating synthetic data from the initial model; obtaining recorded borehole seismic data, wherein the recorded borehole seismic data was obtained with a seismic source or receiver located in a well; and inverting, with a computer, the recorded borehole seismic data by full wavefield inversion, wherein the full wavefield inversion includes comparing the synthetic data to the recorded borehole seismic data, and computing a cost function, obtaining a gradient function from the cost function, wherein the gradient function is related to a change in the objective function with an incremental change in model parameters, using the initial model to compute an illumination function or a resolution function for seismic sources and receivers, and obtaining a conditioned gradient function by conditioning the gradient function with the illumination function or the resolution function.

### CROSS-REFERENCE TO RELATED APPLICATION

This application claims the benefit of U.S. Provisional Patent Application, filed 62/037,464, Aug. 14, 2014, entitled Determination of Subsurface Properties in the Vicinity of a Well by Full Wavefield Inversion, the entirety of which is incorporated by reference herein.

### TECHNOLOGICAL FIELD

Exemplary embodiments described herein pertain to geophysical prospecting and, more particularly, to seismic data processing that includes determining subsurface properties in the vicinity of a well by full wavefield inversion using borehole seismic data.

### BACKGROUND

This section is intended to introduce various aspects of the art, which may be associated with exemplary embodiments of the present technological advancement. This discussion is believed to assist in providing a framework to facilitate a better understanding of particular aspects of the present technological advancement. Accordingly, it should be understood that this section should be read in this light, and not necessarily as admissions of prior art.

### Borehole Seismic Surveys

Subsurface information in the vicinity of a well is useful in order to optimally steer drilling or produce hydrocarbons. One approach for obtaining such information is to record a borehole seismic survey, the most common being the Vertical Seismic Profile (VSP). A VSP is a technique of seismic measurements utilizing down-hole receivers. VSP data usually are obtained by generating one or more shots from a seismic source located in one or more selected positions near the surface. The signal produced by each shot is then detected by multiple receivers located along a well extending into the subsurface formation.

There are many different kinds of VSP's, such as offset-VSP's, walk-away VSP's, walk-over VSP's, etc., which are distinguished by the location of the source and receivers relative to the subsurface target. Equivalently, the sources can be located in the well and receivers on the surface, which is called a Reverse VSP. In addition, both sources and receivers can be in neighboring wells, which is called a Cross well Survey (X-well). VSPs, Reverse VSPs and X-well surveys are types of borehole seismic surveys.

Typically, VSPs utilize receivers located some distance above the target so as to capture and image reflections from a large region of the target. In FIG. 3, a walk-over VSP geometry is shown in which the receivers (303, 307) are located at ½ the distance between the target 302 and the surface sources 304 in order to have good coverage at the target, as indicated by the target region 309. There are other geometries, however, in which the receivers are closer to the target, meaning that the distance from the receiver to the target is less than ½ of the vertical depth between the surface source and the receiver in the well. For example in FIG. 1, receivers 105 are close to the target salt flank 103 and surrounding layers near the well 101. This is called a salt-proximity survey if the sources are above the salt (109), and a salt-flank imaging survey if they are located outside of the salt area (106). A second example, FIG. 2, illustrates the case in which a well 201 is drilled horizontally into or below the target area between interfaces 203 and 204. Again the receivers 210 are close to the target area.

### Extraction of a Single Wave Type

Conventional VSP applications utilize a single wave type, but the recorded wavefield for all VSP data is complex and consists of multiple wave types. Different wave types include down-going compressional waves, down-going multiples, down-going shear waves, down-going converted waves, up-going reflected compressional waves, upcoming reflected shear waves, up-going converted waves, turning waves, etc. Conventional VSP processing uses a wavefield separation step in order to isolate one wave type. This is particularly important for utilizing the weaker events that follow the dominant direct wave. An example of conventional VSP processing using wave-field separation is shown in Krohn et al. (“A cost-effective reservoir imaging method using multiazimuth offset VSPs”, The Leading Edge, 1995, p. 787-794), the entire contents of which are incorporated herein by reference.

VSP wavefield separation methods are generally successful for vertical wells but are less successful for horizontal wells. Most VSP wavefield separation methods are based on the arrival direction of the waves relative to the array of receivers in the well. For example in FIG. 3, the downgoing direct wave 305 arrives at the shallow receiver 303 before it arrives at the deeper receiver 307, but the reverse is true for the upgoing reflection 306 which arrives at the deeper receiver first. A filter based on the time dip or apparent velocity along the wellbore can separate upgoing from downgoing waves and also faster compressional waves from slower shear waves. In a horizontal well with receivers all at the same depth, there is little difference in time moveout for upgoing and downgoing events and filters cannot be used for wavefield separation. (Horizontal wells drilled at high angle from the vertical, so that the well runs parallel to the formation containing oil or gas. They are often used for unconventional reservoirs such as tight gas and oil). For example in FIG. 2, the relative time dip as a function of receiver positions along the well (208 to 210 to 211) for downgoing arrivals 212 is similar to that of upgoing arrivals 213. To process data recorded in horizontal wells, the data window around the first arrivals (212) is simply muted, and remaining is assumed to be upgoing much-later reflections like event 214. By muting around the strong arrival, reflections from targets near the receiver such as event 213, which arrive close in time to the first arrival, are also eliminated and are not imaged or used. In addition, multiples such as event 215 are eliminated.

### Applications of Direct Downgoing Waves

VSP applications can be characterized by the specific wave type exploited after wavefield separation. The first type is the dominate/strong direct arrival for compressional waves and shear waves. An explicit wavefield separation method is not needed, because these are the first-arriving and strongest events. The direct arrival is used to determine the velocity of the formation above the receiver based on the travel time for the detection of these events in the borehole. In the simplest form, a survey to determine time/depth pairs is called a check-shot survey. The source may also be offset horizontally from the well to determine the parameters for velocity anisotropy (See, U.S. Pat. No. 8,407,007 to Bilas, the entire contents of which are hereby incorporated by reference). The direct arrivals (element 305 in FIG. 3) are often used in a tomographic or inversion method using either picked transit times or the seismic waveforms to find the velocity of the region above the receiver.

Geophysical inversion, which is well known to those skilled in the art, attempts to find a model that optimally explains observational data (for example see Tarantola, A., 1986, “A strategy for nonlinear elastic inversion of seismic reflection data,” Geophysics 51(10), pp. 1893-1903.) An example of the seismic inversion method for the VSP direct arrivals is found in U.S. Pat. No. 8,576,663 to van de Mortel, the entire contents of which are hereby incorporated by reference. By way of explanation, in a tomographic or waveform iterative inversion method, a rough velocity model is determined and used to compute simulated travel times or waveforms for propagation of the transmitted seismic waves through the model. The simulated data are then compared to the actual data and the mismatch is used to update the velocity model. The simulation may utilize ray-tracing methods or more compute-intensive wave-equation methods. In the latter case, the method is often called waveform tomography or full waveform inversion (FWI). The process is repeated until the misfit function or objective function is small or no longer decreases. A similar direct-arrival method using sources in a horizontal well and receivers on the surface is described in U.S. Pat. No. 6,725,161 to Hillis et al., the entire contents of which are hereby incorporated by reference.

The direct arrival, sometimes called the transmitted arrival, may also be used to locate a salt flank, sometimes called a salt proximity survey. A specific method to produce a low-resolution image of the salt flank using the transmitted arrival is described in U.S. Pat. No. 8,659,974 to Roberts et al., the entire contents of which are hereby incorporated by reference. In this method, a sediment velocity and a salt velocity is assumed. As in standard Reverse Time Migration (RTM), the recorded receiver data is back propagated with the sediment velocity. In addition, a source wavefield is forward propagated using the salt velocity. The two wavefields are then cross correlated as an imaging condition. The maxia of the cross correlation will indicate the salt-flank location.

### Applications of Other Downgoing Waves

Other applications utilizing the down-going transmitted arrivals exist. U.S. Pat. No. 5,757,723 to Weglein, which is hereby incorporated by reference in its entirety, describes a method of utilizing transmitted down-going multiples to better characterize the subsurface. In addition, U.S. Pat. No. 8,395,965 to Thomson, which is incorporated by reference in its entirety, describes performing a waveform inversion of turning waves. As in the other methods, an important step is to identify and isolate the turning waves in the data and to separate them into up-going and down-going events based on the vertically-separated receivers.

### Applications of Reflected Waves

Another conventional use of VSP's is to image the region below the receiver. In this case, the down-going events are first used to determine velocity. Then down-going events are removed, and further filters are used to isolate one type of up-going wave, particularly the reflected compressional waves. Then, the velocity field is used to image the region below the receivers using these isolated events. The imaging may be of the form of a CMP-transform or a migration in which the reflection events are moved to their corresponding depth position. One of the problems with conventional methods that image the subsurface changes as a function of lateral position from the well is that it is difficult to evaluate the region where the imaging is valid. At the edge of the image, migration swings can create artifacts that appear to be changes in formation properties.

Some conventional methods utilize reflection amplitudes from regions below the receivers to indicate a high impedance change associated with overpressure. For example, U.S. Pat. No. 7,911,878 to Zhao, which is incorporated by reference in its entirety, describes using reflection tomography to determine velocity below a well that may be related to overpressure. Again, these methods utilize one type of wave, which is obtained via a wavefield separate step. In this case, reflections are identified in the data, and their travel times picked. Tomographic inversion is then used to determine the velocity below the well.

The present inventors have recognized that there is a need for improved determination of the formation properties in the vicinity of the well, particularly for horizontal wells. Such determination should overcome the shortcomings of current VSP methods that utilize a single wave type at a time.

### SUMMARY

A method, including: obtaining an initial model of a subsurface property; simulating synthetic data from the initial model; obtaining recorded borehole seismic data, wherein the recorded borehole seismic data was obtained with a seismic source or receiver located in a well; and inverting, with a computer, the recorded borehole seismic data by full wavefield inversion, wherein the full wavefield inversion includes comparing the synthetic data to the recorded borehole seismic data, and computing a cost function, obtaining a gradient function from the cost function, wherein the gradient function is related to a change in the objective function with an incremental change in model parameters, using the initial model to compute an illumination function or a resolution function for seismic sources and receivers, and obtaining a conditioned gradient function by conditioning the gradient function with the illumination function or the resolution function.

### BRIEF DESCRIPTION OF THE DRAWINGS

While the present disclosure is susceptible to various modifications and alternative forms, specific example embodiments thereof have been shown in the drawings and are herein described in detail. It should be understood, however, that the description herein of specific example embodiments is not intended to limit the disclosure to the particular forms disclosed herein, but on the contrary, this disclosure is to cover all modifications and equivalents as defined by the appended claims. It should also be understood that the drawings are not necessarily to scale, emphasis instead being placed upon clearly illustrating principles of exemplary embodiments of the present invention. Moreover, certain dimensions may be exaggerated to help visually convey such principles. Due to patent law restrictions on the use of color, FIG. 4 and FIG. 5 are a black-and-white renditions of original color drawings.

FIG. 1 is an exemplary illustration of the paths of direct and reflected seismic waves from surface sources to receivers in a well under salt.

FIG. 2 is an exemplary illustration of the paths of direct waves, reflected waves and multiples from surface sources to receivers in a horizontal well.

FIG. 3 is an exemplary illustration of the direct and reflected waves for a conventional walk-away VSP with receivers midway between the target and the surface sources.

FIG. 4 illustrates an exemplary application of the present technological advancement.

FIGS. 5A, 5B, and 5C show exemplary cross sections through earth models, including the initial background model, the updated model, and the true model, respectively.

FIGS. 6A, 6B, and 6C show examples of the original and conditioned gradient functions for a single source and the sum of the conditioned gradient for all sources, respectively, recorded through for the earth model of FIG. 5.

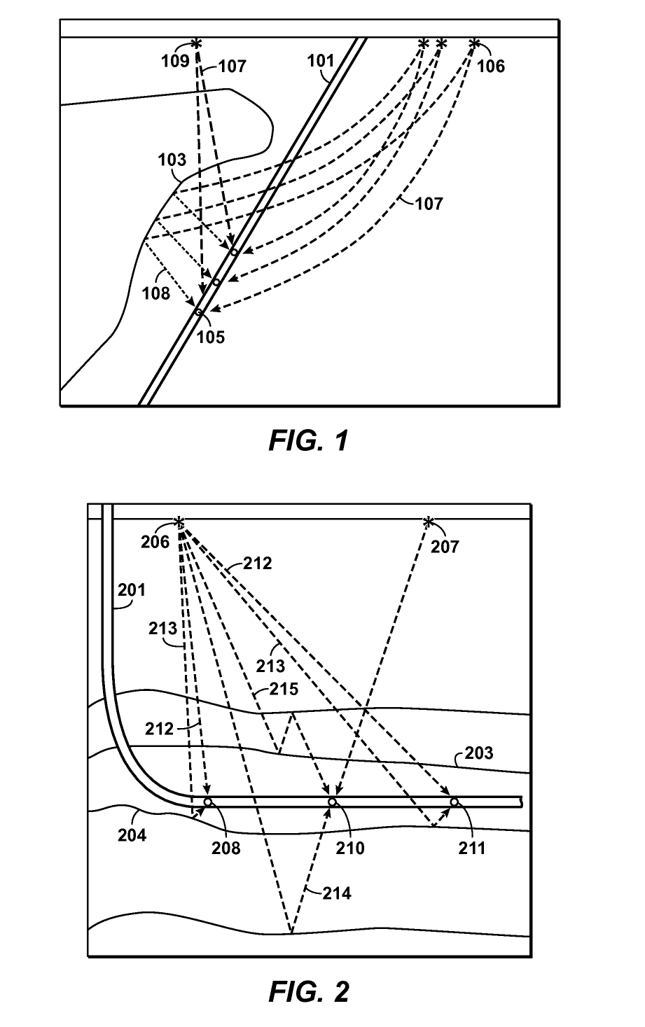

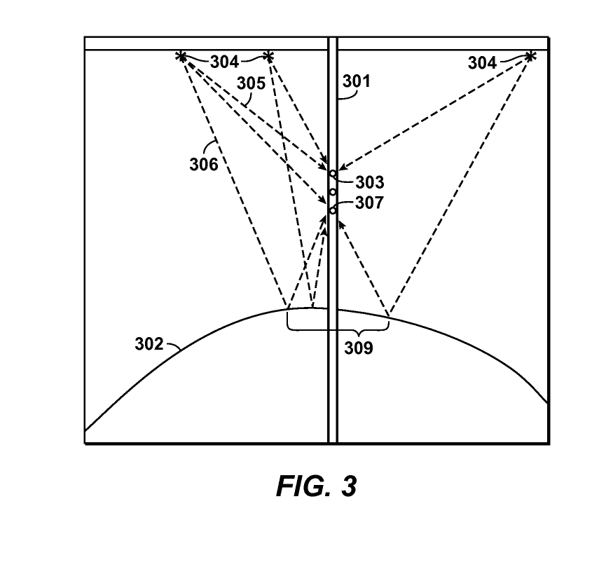

### DETAILED DESCRIPTION

Exemplary embodiments are described herein. However, to the extent that the following description is specific to a particular, this is intended to be for exemplary purposes only and simply provides a description of the exemplary embodiments. Accordingly, the invention is not limited to the specific embodiments described below, but rather, it includes all alternatives, modifications, and equivalents falling within the true spirit and scope of the appended claims.

The present technological advancement can be use to delineate and characterize geological features in the vicinity of a well using borehole seismic data recorded from either sources or receivers in the well or both. In this description, the exemplary embodiments describe VSP applications with sources near the surface of the Earth and receivers in a well. However, because of the principal of seismic reciprocity, this situation may be reversed and one can record the equivalent data using sources in the well and receivers near the surface. Typically, this is called a Reverse-VSP (R-VSP), and the data are equivalent to a VSP. In addition, the present technological advancement is also applicable to the case in which the source is not near the surface but is located in a second well; this type of survey is called a cross-well survey (X-well).

The present technological advancement may be used to delineate and characterized geological features in the vicinity of a well irrespective of the inclination of the well bore; however, illumination is typically better whenever the dip of the borehole is similar to the dip of the target, i.e. a vertical well and vertical salt flank or a horizontal well and horizontal layering. Wells can include vertical wells and deviated wells where a part of the well is at an angle from vertical in the range of from about 15° to about 75° and highly deviated wells where a part of the well is oriented between 75-degrees and 90-degrees off-vertical (wherein 90-degrees off-vertical corresponds to fully a horizontal well bore). A horizontal well generally refers to a well with at least a portion having a centerline which departs from vertical by at least about 65°. In some instances, “horizontal well” may refer to a well which, after reaching true 90° horizontal, may actually proceed upward, or become “inverted.” In such cases, the angle past 90° is continued, as in 95°, rather than reporting it as deviation from vertical, which would then be 85°. In any case, a “horizontal well” may simply be substantially horizontal, such that gravitational force would not cause a particulate to migrate along the length of the well bore.

### Step 401: Obtain Initial Model

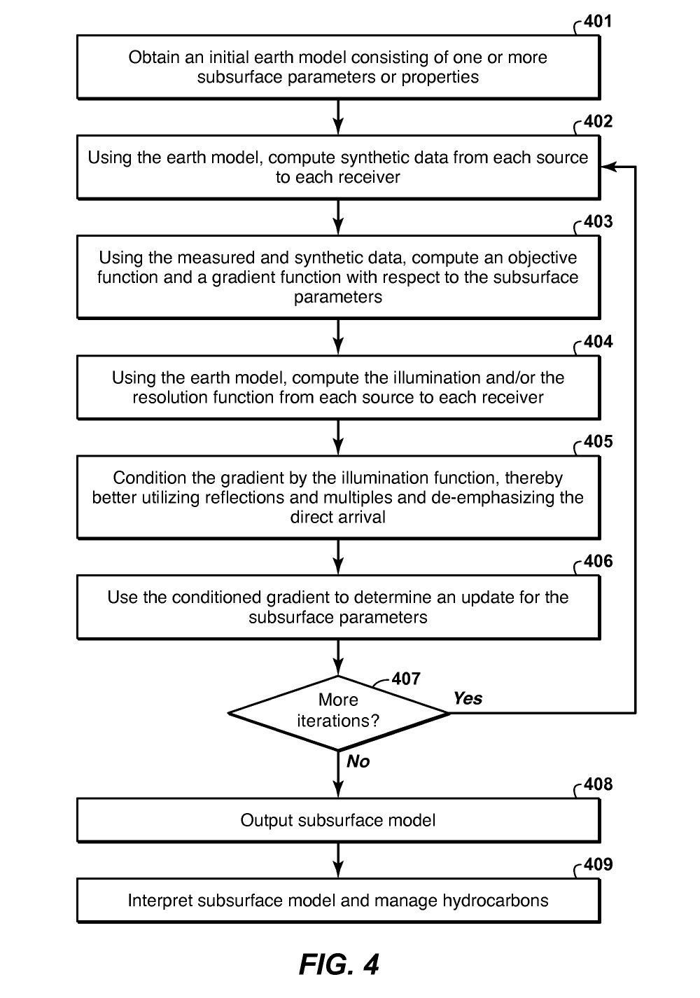

The present technological advance is an improved inversion method that better utilizes multiple wave types and the full complexity of the recorded data. FIG. 4 illustrates an exemplary application of the method. he first step 401 is to derive an initial background subsurface model using conventional methods. The background model is typically a low-resolution model or smooth model. Preferably, all available data types and geological information is integrated to form the initial model. For example, velocities and salt boundaries may be available from surface-seismic data and well-logging data. It is also possible to use VSP, RVSP or X-well data itself The well data can be used simply to determine the velocities in each layer penetrated by the well, but it may be used in any inversion known in the prior art that utilizes the direct wave including first-arrival tomography, waveform tomography, or full waveform inversion (FWI).

Performing step 401 using conventional methods and seismic well data itself, without wavefield separation, will generate updates to velocity largely based on the dominant direct arrival. A more accurate background model can be obtained using just the direct arrivals, because they are the strongest events with the best signal-to-noise and their raypath can be initially computed to lie in a line between the source and receiver. To obtain a velocity model, first-arrival tomography can be performed using first-arrival times picked for the direct wave. This is an iterative method in which a very rough model or velocity gradient is assumed, and then updated so that computed arrival times better match the measured travel times and provide a reliable low-resolution background velocity model. Alternatively, full waveform tomography or inversion may be used, but full-wave inversion (FWI) methods may have problems with local minima in the objective function or cycle-skipping of events and may generate erroneous velocities if the starting model assumed is not good. To reduce local minima issues when using full-wave methods, it may be useful to explicitly isolate the direct arrival by limiting the inversion to time windows around the direct down-going arrivals.

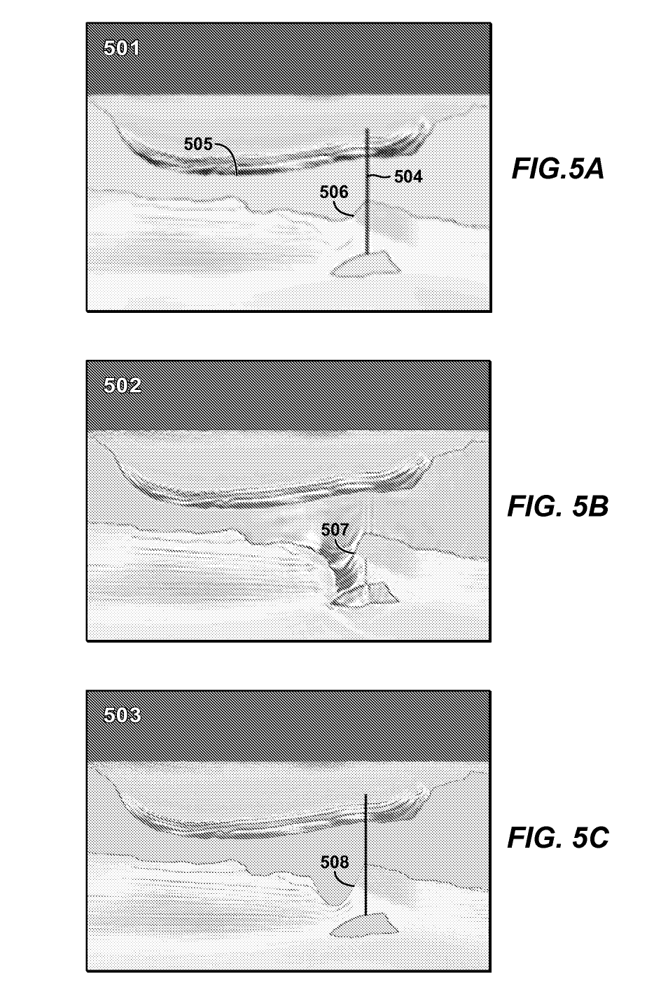

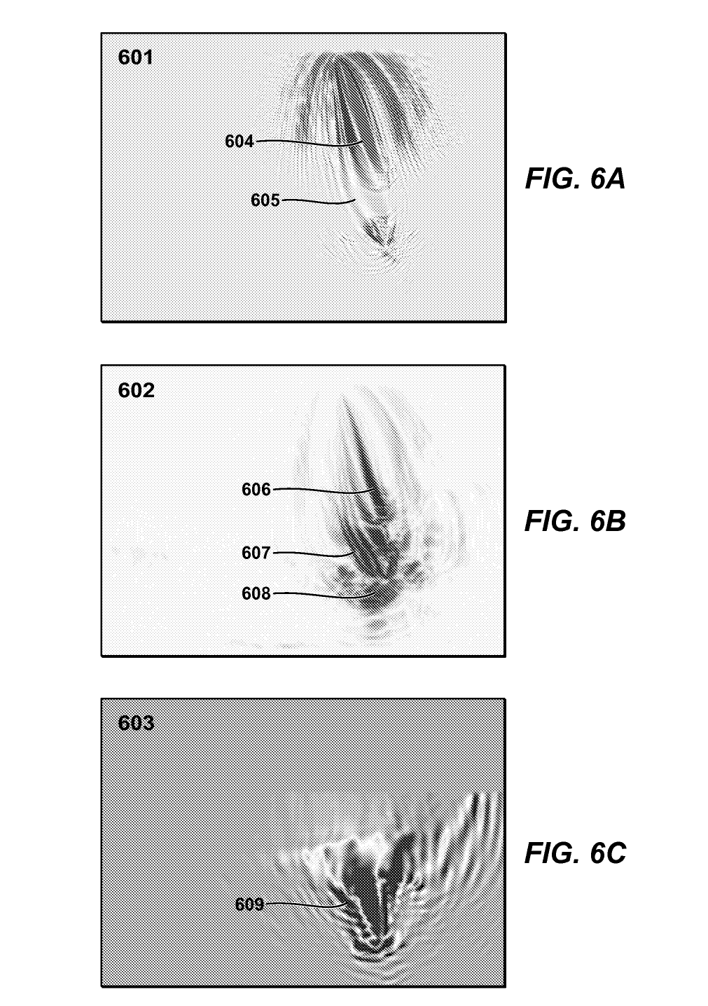

An example of use of the method to determine the location of a salt flank is shown in FIGS. 5-6 using a known model simulation. A geological “true” model is assumed (shown as panel 503) and synthetic data are computed and inverted to test the method. FIG. 5A, panel 501, shows the original background model after step 401. In this panel, the position of the well is indicated as 504, the base of salt is indicated as 505 and the target is shown as 506. (Due to patent law restrictions on the use of color, FIG. 5 is a grey-scale reproduction of original color drawings.)

At this point, the best model using conventional methods (including FWI) has been obtained. The model will be relatively accurate, but have low resolution. It is low resolution because the updates will be along the path of the direct arrivals and direct arrivals have little information about the location of interfaces. The rest of the steps of the present technological advance better utilize the full wavefield, including weak scattering and reflections. We thus call it a “Full Wavefield Inversion”, another variant of FWI.

### Steps 402-403: Simulate Data and Compute Gradient

In step 402, the initial model is used to compute synthetic data for each source and each receiver. This computation preferably will include more than just the direct waves and be computed by solving the wave-equation for seismic wave propagation through the Earth model and include multiple, complex propagation paths and wave types. The simulation may be computed for an acoustic or elastic earth model and also may incorporate anisotropy. The creation of this synthetic data is well known to those of ordinary skill in the art.

Next in step 403, the synthetic data and the measured data are used to compute the objective function. Typically, the objective function is the misfit or difference between the synthetic and measured data raised to some power. For least-square methods, the power is 2 and for sparse inversion the power is 1, but a different power or a fractional power may also be used. The present technological advancement may also use the cross-correlation objective function, which maximizes the cross-correlation of the simulated and measured data. Also in step 403, the gradient in the objective function is computed with respect to the subsurface model parameters. The gradient is related to the incremental change in the objective function with fractional changes in the model parameters.

### Steps 404-406: Compute and Utilize Illumination and Resolution Functions

Next in step 404, the illumination and/or the resolution function is computed. There are a number of both wave-equation and ray-trace methods to compute the illumination and resolution functions known to people working in the technical field. A fuller mathematical description is found in U.S. Pat. No. 8,537,638B2 to Lee et al., which uses such resolution functions to improve the inversion of 3D surface seismic datasets.

The illumination function can be computed for each source and each receiver. The illumination function relates to the ability of seismic waves propagating from a source or to a receiver to illuminate or to provide useful information about a point location in the subsurface. The illumination function can depend strongly on the position of the source or receiver and the properties of the medium, particularly its velocity. Better illumination means that the subsurface point is queried by seismic energy from a variety of different angles (wavenumbers) and frequencies, not just a straight-path penetration.

The resolution function can be thought of as the minimal volume at the subsurface point that can be resolved considering the source and receiver positions and the subsurface properties. The resolution function is related to the illumination function.

In step 405, the illumination function and/or resolution function is used to condition the gradient computed in step 403, and the conditioned gradient is then used to update the velocity model in step 406. By condition, the illumination function and/or resolution function (or their inverses) are used multiply or weight the gradient. The update step 406 can use any optimization method known in the art, such as steepest descent, conjugate gradient or Newton method.

FIG. 6 illustrates the conditioning of the gradient in step 405. (Due to patent law restrictions on the use of color, FIG. 6 is a grey-scale reproduction of original color drawings.) The original gradient function after step 403 is shown for one source location as panel 601. The panels in FIG. 6 cover the same subsurface area illustrated by the images in FIG. 5. The gradient function is dominated by the single, straight-line path of the high-amplitude direct arrival as indicated by 604. This area is the principal area that would be updated by inversion if this gradient (without conditioning by the illumination and/or resolution functions) were used, as in conventional methods. Other areas such as 605 are weaker and the updates will be small in this region. The conditioned gradient of the present technological advancement, after compensating for the illumination function and/or resolution function in step 405, is shown in panel 602. The direct arrival 604 has been de-emphasized as indicated by reference number 606. Other areas such as 607 and 608 around the target 607 have been emphasized allowing the information in the reflections and multiples to better update the target in the iterative inversion process.

Steps 404-405 de-emphasize the direct arrival and allow the other events such as multiples and reflections and scattering to contribute more to the model update in step 406. The unconditioned gradient is dominated by the wave-types with the largest amplitudes, particularly the strong direct arrivals. The direct arrivals were useful in step 401 in deriving a background model, but they provide less high-resolution and multiple-angle information for areas in the vicinity of the borehole compared to other arrivals such as reflections, multiples, and scattered energy. By conditioning the gradient by the illumination and/or resolution functions, the information content of the complex wavefield is able to be more fully used instead of being dominated just by the high-amplitude events.

In addition to better use of the complex wavefield, using illumination and/or resolution functions to condition the gradient for borehole recorded data is advantageous because the subsurface illumination is severely limited by the position of the well and the background velocity. The illumination from VSP is quite variable and without compensation artifacts and false structures can be generated. Conditioning the gradient by the illumination function can limit the inversion from updating the model where the illumination or information is inadequate.

Even though U.S. Pat. No. 8,537,638B2 to Lee et al. describes examples of illumination and resolution functions for 3D surface seismic data; the present technological advancement for borehole seismic data is different. The 3D dataset described by Lee does not have both transmitted and reflected waves near the target at depth, and illumination is less variable. Lee et al. solves the problem of long compute times for large 3D surface-seismic datasets. The computational speed up described by Lee comes largely by conditioning the gradient by the resolution function so that the inversion spends less time updating features too small to resolve. In contrast, borehole-seismic data volumes are much, much less than 3-D surface-seismic volumes and computational time is not an issue. As is further described by Lee et al., conditioning by all three functions of resolution, illumination and background media properties allows model parameters, such as density, to be determined with the correct units, avoiding the need for a scaling operation. The advantage of avoiding this extra step is minimal The present technological advance is different. With well-data, the primary concern is optimally using multiple wave types, each with variable illumination. In the case of borehole data, the illumination function is critical, particularly because the illumination of borehole data is so variable.

### Steps 407-408: Iteratively Update and Output Results

Next in step 407, the updated model is then judged to be sufficient (i.e. the update or objective function is small). If sufficient, the updated model is output as the final subsurface model. If not, it is used as the new “initial” earth model and the steps 402-406 are repeated.

The updated model after step 408 is illustrated in FIG. 5B, panel 502, in which the subsurface target of 506 has been updated to a new position 507. The updated model compares favorably to the true model shown in panel 503, and the inverted target 507 can be compared to the true target 508, in panel 503 of FIG. 5C.

### Region of Influence where Updates are Valid

In step 408, it can also be determined whether or not the region of influence in which the inversion was performed as part of step 406 can be trusted. This analysis can include analyzing the conditioned gradient to confirm the validity of the updated region of the subsurface model. In FIG. 6, panel 603 is the sum of the conditioned gradients for the sum of all sources. The darker region 609 shows the area that has been reliably updated. This comparison can be used as an indicator of the region of influence to validate the final inverted model 602. For example, the output properties in the gray areas outside of region 609, should be less reliable than the areas inside region 609.

Another method to determine the validity of the output subsurface model is to compute a metric called the volume of investigation (VOI) (see, Miller, C. R., and Routh, P. S., 2007, “Resolution analysis of geophysical images: Comparison between point spread function and region of data influence measures”, Geophysical Prospecting 55, No. 6, 835-852). The method generates and compare inverted output models starting using two slightly different background models m₁^{start}; m₂^{start}. First an initial velocity model m₁^{start} is obtained. Again Steps 402-408 are performed to obtain the results m₁^{inverted}. Then a new initial model m₂^{start} is determined that differs from the first model in some manner. Again Steps 403-408 are performed to obtain m₂^{inverted}. In the region where the data are sensitive to the model, the two inverted models m₁^{inverted}; m₂^{inverted} will be similar, and in the region where data are not sensitive to the model, the inverted models will revert back to starting models. VOI is then defined as the ratio of (m₁^{inverted}−m₂^{inverted})/(m₁^{start}−m₂^{start}). In the region of “good” illumination, and in VOI will be close zero and in the region of “poor” illumination VOI will be close to unity.

### Step 409: Hydrocarbon Management

Finally in step 409, hydrocarbons are managed according to the output subsurface model. As used herein, hydrocarbon management includes hydrocarbon extraction, hydrocarbon production, hydrocarbon exploration, identifying potential hydrocarbon resources, identifying well locations, determining well injection and/or extraction rates, identifying reservoir connectivity, acquiring, disposing of and/or abandoning hydrocarbon resources or produced fluids, reviewing prior hydrocarbon management decisions, and any other hydrocarbon-related acts or activities.

### Computer Implementation

The steps in the method of FIG. 4, like all iterative inversion methods, require computation using a computer. Preferably, in order to solve the wave equation in a complex model, the computer is a high performance computer (HPC), known as to those skilled in the art, Such high performance computers typically involve clusters of nodes, each node having multiple CPU's and computer memory that allow parallel computation. The models may be visualized and edited using any interactive visualization programs and associated hardware, such as monitors and projectors. The architecture of system may vary and may be composed of any number of suitable hardware structures capable of executing logical operations and displaying the output according to the present technological advancement. Those of ordinary skill in the art are aware of suitable supercomputers available from Cray or IBM.

### Applications of Technological Advancement

The present technological advancement enables high-resolution properties or images to be obtained in the vicinity of a well that are not available with other methods, because it optimally uses the full complex wavefield and simultaneously incorporates transmitted waves, reflected waves, scattered waves and multiples without requiring wavefield separation. The present technological advancement can be used with any VSP, RVSP or cross-well dataset, but it is most useful when the receivers are close to the target so that reflections from the target and the direct wave arrive at the receiver within the same time window.

As discussed in the background section, it is difficult to perform conventional wavefield separation with horizontal wells. The present technological advancement avoids that difficulty because wavefield separation is not required. Consequently, the present technological advancement can be particularly useful for unconventional reservoirs involving tight gas or tight oil and horizontal wells.

The present technological advancement can be used in conjunction with receivers deployed in multiple neighboring wells simultaneously. In this case, it can be used to obtain an inverted 3-D subsurface model in the vicinity of the multiple wells. The present technological advancement can also be used on data that is recorded during the drilling of the well (seismic while drilling) and used to steer the well to an optimal location. Recordings can be made with deployed sources and receivers or with sources and receivers permanently installed along the annulus of the wells. The images obtained can be used to optimally position the wells, to determine the optimal spacing of multiple wells and to optimize the pattern of perforating, fracking and producing the reservoir from each well. In addition, recordings can be performed periodically for time-lapse or 4D recording to monitor the hydrocarbon production.

The present techniques may be susceptible to various modifications and alternative forms, and the examples discussed above have been shown only by way of example. However, the present techniques are not intended to be limited to the particular examples disclosed herein. Indeed, the present techniques include all alternatives, modifications, and equivalents falling within the spirit and scope of the appended claims.

What is claimed is:

1. A method, comprising:
obtaining an initial model of a subsurface property;
simulating synthetic data from the initial model;
obtaining recorded borehole seismic data, wherein the recorded borehole seismic data was obtained with a seismic source or receiver located in a well;
inverting, with a computer, the recorded borehole seismic data by full wavefield inversion, wherein the full wavefield inversion includes
comparing the synthetic data to the recorded borehole seismic data, and computing a cost function,
obtaining a gradient function from the cost function, wherein the gradient function is related to a change in the objective function with an incremental change in model parameters,
using the initial model to compute an illumination function or a resolution function for seismic sources and receivers,
obtaining a conditioned gradient function by conditioning the gradient function with the illumination function or the resolution function, wherein the obtaining includes simultaneously using an entire full complex wavefield from the recorded borehole seismic data; and
using the conditioned gradient function to determine an updated subsurface property model from the initial model.

2. The method of claim 1, wherein the well is a horizontal well with deviations from the vertical of over 65 degrees.

3. The method of claim 1, wherein the conditioned gradient function de-emphasizes direct arrivals from the seismic sources to the receivers within the recorded borehole seismic data.

4. The method of claim 1, wherein the conditioned gradient function emphasizes reflected waves and multiples from the seismic sources to the receivers within the recorded borehole seismic data.

5. The method of claim 1, wherein the conditioning the gradient function includes using only the illumination function.

6. The method of claim 1, wherein the conditioning the gradient function includes using only the resolution function.

7. The method of claim 1, wherein the conditioning the gradient function includes using only the resolution function and the illumination function.

8. The method of claim 1, wherein the obtaining the initial model includes deriving the initial model from only direct arrivals included in the recorded borehole seismic data.

9. The method of claim 1, further comprising using the updated subsurface model to manage hydrocarbons.

10. The method of claim 1, further comprising:
using the updated subsurface model to characterize geological features near the well.

11. The method of claim 1, further comprising:
not applying a wavefield separation step to the recorded borehole seismic data.

12. The method of claim 1, further comprising:
validating an updated region of the updated subsurface model by analyzing the conditioned gradient.

13. The method of claim 1, further comprising:
validating that an updated region of the updated subsurface property model incorporates a volume of investigation, wherein the initial model is m₁^{start} and the updated subsurface property model is m₁^{invert}, then further comprising repeating the inverting with a second model m₂^{start} to obtain a corresponding updated model m₂^{invert}, wherein the volume of investigation is computed as a ratio (m₁^{invert}−m₂^{invert})/(m₁^{start}−m₂^{start}).
